(19) United States
(12) Patent Application Publication
(10) Pub. No.: US 2017/0302670 A1
(43) Pub. Date: Oct. 19, 2017

(54) METHOD, DEVICE, AND SYSTEM FOR EXECUTING NETWORK SERVICE

(71) Applicant: Beijing Xiaomi Mobile Software Co., Ltd., Beijing (CN)

(72) Inventors: Mingjun YIN, Beijing (CN); Deguo Meng, Beijing (CN); Enxing Hou, Beijing (CN)

(21) Appl. No.: 15/440,143

(22) Filed: Feb. 23, 2017

(30) Foreign Application Priority Data
Apr. 14, 2016 (CN) 201610230765.3

(51) Int. Cl. H04L 29/06

(52) U.S. Cl. CPC H04L 63/10; H04L 63/083

(57) ABSTRACT

A method for executing a network service includes: receiving a network service request sent by a first terminal, the network service request including a target identification; determining a second terminal corresponding to the target identification according to a pre-stored corresponding relationship between identification information and verification terminals, and sending a verification request to the second terminal; and when receiving a verification confirmation message from the second terminal, executing a network service corresponding to the network service request.

### CROSS-REFERENCE TO RELATED APPLICATIONS

This application is based upon and claims priority to Chinese Patent Application No. 201610230765.3, filed Apr. 14, 2016, the entire contents of which are incorporated herein by reference.

### TECHNICAL FIELD

The present disclosure generally relates to the field of computer, and more particularly, to a method, device, and system for executing a network service.

### BACKGROUND

As the computer technology advances, more and more application programs become available. Network services also become richer and more diversified. As to a network service, such as network payment and viewing of important documents, having a relatively high security requirement, a user not only sets an account and a login password for an application program associated with the network service, but also sets an independent executing password for the network service.

In the related art, when a second user wants to use an account of a first user to receive a network service having a high security, the second user may uses an application installed in a terminal to log into the account of the first user. Generally, when the application in the terminal is open, login is automatic without a user input. The second user may inquire the first user of the password for receiving the network service of the account. After the first user informs the second user of the corresponding password, the second user may use the account of the first user to receive the network service.

### SUMMARY

According to one aspect of the present disclosure, there is provided a method for executing a network service. The method includes: receiving a network service request sent by a first terminal, the network service request including a target identification; determining a second terminal corresponding to the target identification according to a pre-stored corresponding relationship between identification information and verification terminals, and sending a verification request to the second terminal; and when receiving a verification confirmation message from the second terminal, executing a network service corresponding to the network service request.

According to another aspect of the present disclosure, there is provided a server, including a processor and a memory for storing instructions executable by the processor. The processor is configured to: receive a network service request sent by a first terminal, the network service request including a target identification; determine a second terminal corresponding to the target identification according to a pre-stored corresponding relationship between identification information and verification terminals, and send a verification request to the second terminal; and when receiving a verification confirmation message from the second terminal, execute a network service corresponding to the network service request.

According to another aspect of the present disclosure, there is provided a first terminal, including a processor and a memory for storing instructions executable by the processor. The processor is configured to: receive a network service instruction in a remote verification mode inputted by a user; and send a network service request to a server, wherein the network service request includes a target identification for enabling the server to determine a second terminal corresponding to the target identification according to a pre-stored corresponding relationship between identification information and verification terminals, send a verification request to the second terminal, and when receiving a verification confirmation message from the second terminal, execute a network service corresponding to the network service request.

According to another aspect of the present disclosure, there is provided a method for executing a network service. The method includes: receiving a network service instruction in a remote verification mode inputted by a user; and sending a network service request to a server based on the network service instruction, wherein the network service request includes a target identification for enabling the server to determine a second terminal corresponding to the target identification according to a pre-stored corresponding relationship between identification information and verification terminals, send a verification request to the second terminal, and when receiving a verification confirmation message from the second terminal, execute a network service corresponding to the network service request.

According to another aspect of the present disclosure, there is provided a system for executing a network service. The system includes a server and a first terminal. The first terminal receives a network service instruction in a remote verification mode inputted by a user, and sends a network service request to the server based on the network service instruction, the network service request including a target identification. The server receives the network service request from the first terminal, determines a second terminal corresponding to the target identification according to a pre-stored corresponding relationship between identification information and verification terminals, sends a verification request to the second terminal, and when receiving a verification confirmation message from the second terminal, executes a network service corresponding to the network service request.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for performing a network service, according to an exemplary embodiment.

FIG. 2 is a schematic diagram showing an interface displayed on a first terminal, according to an exemplary embodiment.

FIG. 3 is a schematic diagram showing an interface displayed on a second terminal, according to an exemplary embodiment.

FIG. 4 is a schematic diagram showing an interface displayed on a second terminal, according to an exemplary embodiment.

FIG. 5 is a flow chart of a method for performing a network service, according to an exemplary embodiment.

FIG. 6 is a block diagram illustrating a server, according to an exemplary embodiment.

FIG. 7 is a block diagram illustrating a server, according to an exemplary embodiment.

FIG. 8 is a block diagram of a first terminal, according to an exemplary embodiment.

FIG. 9 is a block diagram of a first terminal, according to an exemplary embodiment.

FIG. 10 is a structural diagram of a server, according to an exemplary embodiment.

FIG. 11 is a structural diagram of a terminal, according to an exemplary embodiment.

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

An exemplary embodiment of the present disclosure provides a method for performing a network service. The method for performing a network service may be implemented by a server and a first terminal. The server may be a background server for an application program, such as a cloud application program. The server may be provided with a first processor, a first memory, a first transceiver, and the like. The first processor is configured to execute a procedure of the network service. The first memory may be used for storing data required during performing the network service and the generated data. The first transceiver is configured to receive and send messages. The first terminal may be a smart phone, a tablet computer, a smart TV, and the like. The first terminal may be installed with an application program for a target network service. The first terminal may include a second processor, a second memory, a second transceiver, and the like. The second processor is configured to execute a procedure of the network service. The second memory may be used for storing data required in performing the network service and the generated data. The second transceiver is configured to receive and send messages. The first terminal may also be provided with an input/output device, such as a screen. The screen may be used for displaying an application program interface and the like. The screen may be a touch screen.

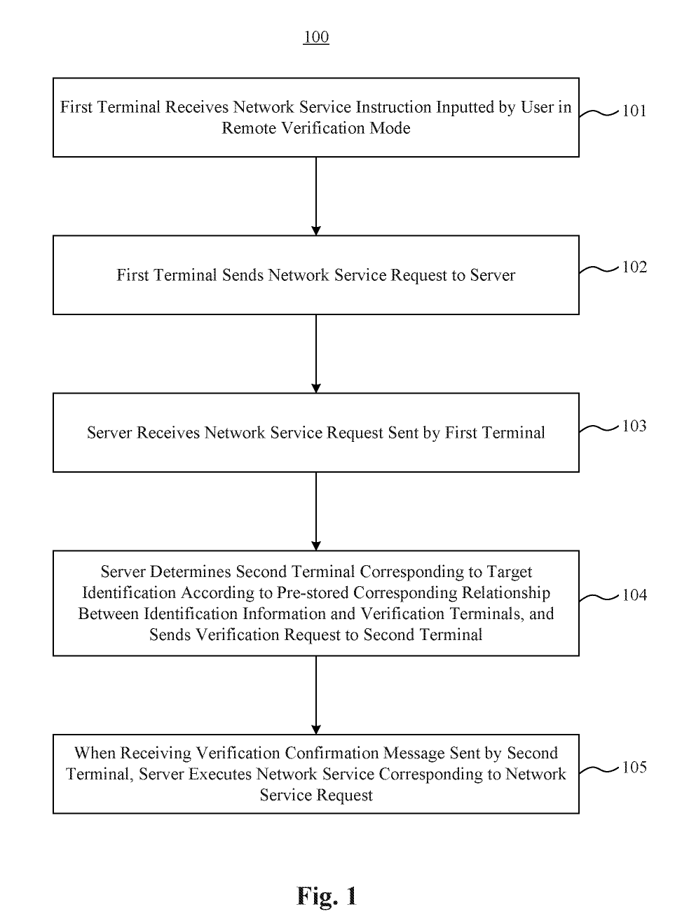

FIG. 1 is a flowchart illustrating a method 100 for performing a network service, according to an exemplary embodiment. As shown in FIG. 1, the method 100 may include the following steps.

In step 101, a first terminal receives an instruction for a network service inputted by a user in a remote verification mode.

In one embodiment, a first user may install an application program in the first terminal and start the application program. The first user may use a target account to log in the application program, and set up a verification terminal for authorizing usage of a network service in the application program. The procedure of setting up the verification terminal will be described in detail later.

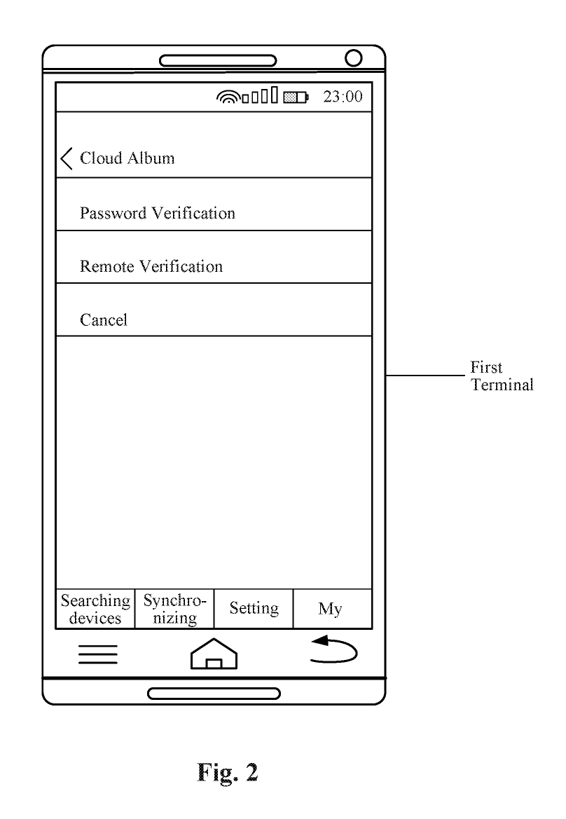

When the application program is logged in with the target account, the first terminal records a target identification corresponding to the target account. The target identification is a unique identification for identifying the target account that is used to log in the application program of the first terminal. The target identification may be an ID (identification) of the target account, a connection identification between the first terminal and a server, or the like. When a second user uses the first terminal and opens the application program, the application program remains logged in with the target account. The second user may wish to receive a target network service, such as viewing a cloud album or making a payment, in the application program. The second user may select one of the target network services provided by the application program. As shown in FIG. 2, a “Cloud Album” network service is selected by the second user. The selection causes the first terminal to display options that the second user may choose to receive the network service. For example, as shown in FIG. 2, the first terminal displays password verification and remote verification for the second user to choose to view the cloud album. Also for example, the second user selects the option of remote verification to receive the network service. The selection by the second user constitutes an instruction for the network service received by the first terminal.

In one embodiment, the first user sets a remote verification for using a cloud album that can be displayed on, e.g., a smart TV in the house. The first user uses the target account to log in the application program so that when the application program is opened, the application program is logged in and ready for use. When the second user turns on the smart TV and opens the application program, the smart TV may show that the application program is logged in with the target account. When the second user wants to view the cloud album in the application program of the smart TV, the second user may select an icon of the cloud album, which causes the smart TV to display the options of verification to view the album, such as password verification and remote verification. In the password verification mode, the second user needs to enter a verification password to unlock the cloud album. In the remote verification mode, the second user sends a request for viewing the cloud album to the owner of the cloud album, the first user, who may grant the request remotely. When the second user selects the option of remote verification, the smart TV receives an instruction of viewing the cloud album.

In some embodiments, when the second user wishes to use a target network service, the second user may select the target network service on the first terminal. The selection by the second user causes the first terminal to display the options of password verification and remote verification. When the second user selects the option of remote verification, the first terminal is caused to display an input box for entering user information. The second user may input information of himself or herself, such as his or her name, in the input box. The second user may then click a confirmation key so that the first terminal receives the network service instruction inputted by the second user.

In step 102, the first terminal sends a network service request to the server. The network service request includes a target identification.

The target identification is identification information for uniquely identifying the target account that is used to log in the application program of the first terminal. The target identification may be an ID of the target account, a connection identification between the first terminal and the server, or the like.

In some embodiments, when the network service instruction inputted by the user is detected, the first terminal may send a network service request to the server. The network service request includes a service identification of the target network service. For example, the second user selects a viewing key in the cloud album. Upon detecting the instruction of viewing the cloud album inputted by the second user, the smart TV may send a request for viewing the cloud album to the server.

In one embodiment, the network service request sent by the first terminal to the server includes a terminal identification of the first terminal.

The terminal identification of the first terminal may be a terminal type, such as Redmi mobile phone or Xiaomi TV. The terminal identification of the first terminal may also be a name set by the user for the first terminal.

In some embodiments, when the network service instruction inputted by the user is detected, the first terminal acquires the terminal identification of the first terminal, and sends a network service request to a server. The network service request includes the terminal identification of the first terminal and a service identification of the target network service.

In step 103, the server receives the network service request sent by the first terminal. The network service request includes the target identification.

The target identification is an identification for uniquely identifying the target account that is used to log in the application program of the first terminal. The target identification may be an ID of the target account, a connection identification between the first terminal and the server, or the like.

In one embodiment, after receiving the network service request sent by the first terminal, the server may parse the network service request to obtain the target identification of the target account and/or the service identification of the target network service.

In step 104, the server determines a second terminal corresponding to the target identification according to a pre-stored corresponding relationship between identification information and verification terminals, and sends a verification request to the second terminal. The corresponding relationship is stored in a memory device.

The second terminal may be a mobile phone, a tablet computer, and the like, and may log into the target account. The second terminal is a verification terminal that a user designates for the target account, which is the account used to log in the application program in the first terminal. When the first terminal requests the server to execute a network service while the target account is used to log in the application program, the network service can be executed when obtaining an approval/verification from the second terminal associated with the target account. The verification request is sent by the server to the verification terminal, the second terminal in the present embodiment, for inquiring whether the user of the verification terminal allows the corresponding network service to be performed, such as viewing the cloud album.

In some embodiments, the server may store a corresponding relationship between the identification information and the verification terminals in advance. The procedure of storing the corresponding relationship between the identification information and the verification terminals will be described in detail below. After receiving the network service request sent by the first terminal, the server may acquire the target identification of the target account that is used to log in the application program in the first terminal. The server may look for the second terminal, i.e., the verification terminal for authorizing the target network service, corresponding to the target identification in the pre-stored corresponding relationship between the identification information and the verification terminals. The server then sends the verification request to the second terminal. The verification request may include the service identification of the target network service.

In some embodiments, when sending the verification request, the server may also send user information of the first terminal to the second terminal. The user information of the first terminal may be obtained by parsing the network service request sent by the first terminal.

In some embodiments, the network service request includes the terminal identification of the first terminal, and the server sends the verification request including the terminal identification of the first terminal to the second terminal.

In this way, the user may know which terminal requests the verification.

The terminal identification of the first terminal may be a terminal type, such as Redmi mobile phone or Xiaomi TV. The terminal identification of the first terminal may also be a name set by the user for the first terminal.

In some embodiments, after searching the second terminal according to the target identification from the pre-stored corresponding relationship between the identification information and the verification terminals, the server may acquire the terminal identification of the first terminal, and then send a verification request including the terminal identification of the first terminal to the second terminal.

In step 105, when receiving a verification confirmation message sent by the second terminal, the server executes a network service corresponding to the network service request.

The verification confirmation message is sent by the verification terminal to the server, for authorizing the server to execute the network service corresponding to the network service request.

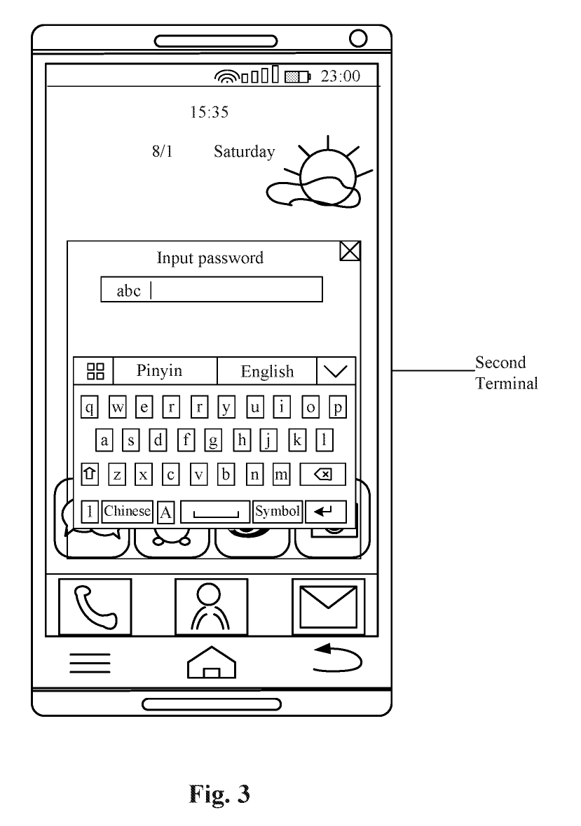

In some embodiments, after receiving the verification request sent by the server, the second terminal may display the verification request in an interface for the first user to see. If the first user grants the request, the first user may select a response to the verification request by, for example, clicking a confirmation key. After detecting an instruction indicating first user's response to the verification request, the second terminal may send the verification confirmation message to the server. For example, a smart TV may send a request for displaying a cloud album. The server then sends a verification request to a smart phone associated with the first user. FIG. 3 illustrates a user interface displayed on a smart phone. As shown in FIG. 3, the first user may enter a password to grant the request for displaying the cloud photo album.

After receiving the verification confirmation message sent by the second terminal, the server executes the network service corresponding to the network service request, and sends an execution result to the first terminal. After receiving the execution result, the first terminal may display the execution result, such as displaying images in the cloud album on the first terminal. For example, when the second terminal receives a verification request from the first terminal for viewing a cloud photo album sent by the server, the first user may click the confirmation key on the second terminal. After detecting that the confirmation key has been selected, the second terminal sends the verification confirmation message granting the request to the server. After receiving the verification message indicating the request for network service is granted, the server may unlock a password-protected cloud album with the password, and send the unlocked cloud album to the first terminal. After receiving the unlocked cloud album, the first terminal may display the images in the unlocked cloud album.

In some embodiments, the verification request sent by the server and received by the second terminal may include the user information of the user requesting the network service. For example, San ZHANG uses a smart TV or a Redmi mobile phone to request to view the cloud album. The verification request may include San ZHANG's information. The first user may decide whether to allow San ZHANG to use the smart TV or Redmi mobile phone to view the cloud album based on San ZHANG's information.

In some embodiments, the verification confirmation message may include a verification password. When the first user is prompted to decide whether to grant the verification request, the first user may be required to enter the verification password, which is then included in the verification confirmation message generated by the second terminal. When receiving the verification confirmation message sent by the second terminal, the server extracts the verification password and compares it with a pre-stored verification password of the target account. If they match with each other, the server executes the network service corresponding to the network service request.

In some embodiments, the server may store the verification password of the target account in advance. The procedure of storing the verification password of the target account in advance will be depicted in detail later.

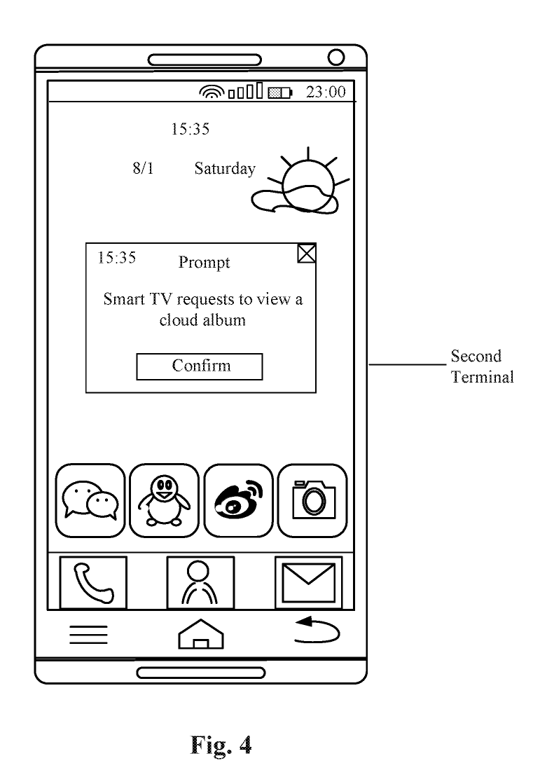

FIG. 4 illustrates a user interface displayed on the second terminal, e.g., a smart phone. As shown in FIG. 4, a verification request (e.g., “Smart TV requests to view a cloud album”) is displayed in the user interface. After the first user selects “Confirm,” the second terminal displays an input box for the first user to input a verification password, as shown in FIG. 3. The first user may input a verification password corresponding to the target network service in the input box, and click a confirmation key so that the second terminal sends the verification confirmation message including the verification password to the server. After receiving the verification confirmation message sent by the second terminal, the server may parse the verification confirmation message, acquire the verification password included in the verification confirmation message, and compare the acquired verification password with the pre-stored verification password of the target network service of the target account. If they match with each other, the network service corresponding to the network service request is executed, and an execution result is sent to the first terminal.

For example, the verification request sent by the server and received by the second terminal indicates that the first terminal requests to pay 23.68 yuan. The first user may grant the verification request by, for example, clicking a confirmation key, which causes the second terminal to display a password input box. The first user may input a verification password, e.g., 123856, and clicks a confirmation key to cause the second terminal to send the verification confirmation message including the verification password to the server. After receiving the verification confirmation message, the server may parse the verification confirmation message, acquire the verification password, and compare the verification password with the pre-stored password of the target account. If they match each other, the server executes a payment operation, and sends a message indicating the payment is successful, to the first terminal. The first terminal may display an interface showing a payment has been successfully made.

In some embodiments, different verification passwords may be set for respective network services in the application program. For example, viewing a cloud album, making a payment, and viewing chat records may each associated with a different verification password. When receiving the verification request for the target network service sent by the server, the second terminal may display the verification request for the target network service in an interface. For example, the verification request may indicate that the first terminal requests to view a cloud album or to make a payment. The first user may grant the verification request by, for example, clicking a confirmation key to cause the second terminal to display an input box for inputting a verification password. The first user may input a verification password corresponding to the target network service in the input box, and click a confirmation key to cause the second terminal to send a verification confirmation message including the verification password of the target network service to the server. After receiving the verification confirmation message sent by the second terminal, the server may parse the verification confirmation message to obtain the verification password of the target network service included in the verification confirmation message, and compare the obtained verification password with a pre-stored verification password of the target network service of the target account. If they match with each other, the server executes the network service corresponding to the network service request.

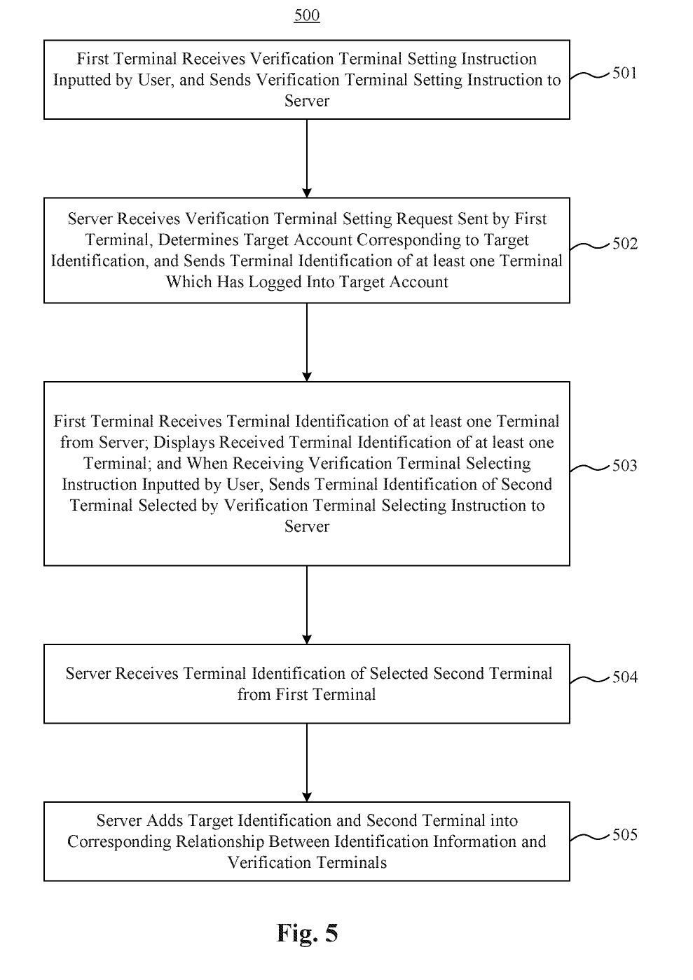

The present disclosure also provides a process for setting a verification terminal for a network service in an application program. FIG. 5 is a flow chart illustrating a method 500 for setting a verification terminal to grant a request for a network service, according to an exemplary embodiment. As shown in FIG. 5, the method 500 may include the following steps.

In step 501, a first terminal receives a verification terminal setting instruction inputted by a user, and sends a verification terminal setting request to a server.

In some embodiments, a first user may use any terminal to install an application program that allows the first user to designate a verification terminal. The first user uses a target account to log in the application program to set up a verification terminal for granting network services in the application program. In one embodiment, a verification terminal may be designated for granting a plurality of network services. In another embodiment, different verification terminals may be designated for granting different network services, respectively. In the present embodiment, the procedure of designating a verification terminal for granting a target network service on the first terminal will be depicted in details hereafter.

In one embodiment, the first user may install an application program in the first terminal and use the target account to log in the application program. The first user may select a setting option in an interface to cause the first terminal to display a plurality of setting options, including, for example, an access setting option, an interface setting option, and some other options. The first user may select the access setting option to cause the first terminal to display an access authorization for network services and a uniform setting option that allows the first user to designate one verification terminal for all the network services. The first user may select a target network service option to cause the first terminal to display, for example, an edit option, an authorization setting option, and some other options. The first user may select the authorization setting option to cause the first terminal to display, for example, a password setting option and a verification terminal setting option. The first user may select the verification terminal setting option to designate a verification terminal for granting network service(s). After receiving an input/instruction from the first user for setting the verification terminal, the first terminal may send a verification terminal setting request to the server. The verification terminal setting request may include at least one of a target identification of the target account that is used to log in the application program, a terminal identification of the first terminal, or a service identification of the target network service.

In step 502, the server receives the verification terminal setting request sent by the first terminal, determines the target account corresponding to the target identification, and sends a terminal identification of at least one terminal that logged into the target account in the past, to the first terminal.

In this way, the verification terminal may be quickly set.

In some embodiments, when the target account is used to log in the application program, the server may detect the terminal in which the target account is used. The server may add a terminal identification of the terminal into a database indicating a corresponding relationship between the target account and the terminals which have logged into the target account. For example, the first user may use the target account in terminals, such as a smart TV, a smart phone, a tablet, a computer, and a laptop to log in the application program installed in those devices. The server may maintain a database associating the terminal identifications of those devices with the target account.

After receiving the verification terminal setting request sent by the first terminal, the server may parse the verification terminal setting request to obtain the terminal identification of the first terminal and the service identification of the target network service. The server determines the target identification corresponding to the target account, which is used to log in the application program in the first terminal. According to the target identification of the target account, the server determines a terminal identification of at least one terminal other than the first terminal, which has logged in to the target account, based on the corresponding relationship between the target identification and the terminals which has logged into the target account. The server sends the obtained terminal identifications of the terminals which have logged into the target account to the first terminal.

In step 503, the first terminal receives the terminal identification of at least one terminal which has logged into the target account and displays the received terminal identification of the at least one terminal. The first user may select a verification terminal by choosing a terminal identification displayed on the first terminal. When receiving a verification terminal selecting instruction inputted by the user, i.e., the user's selection of a terminal identification, the first terminal sends the terminal identification of the selected verification terminal to the server.

In this way, the user may select the verification terminal according to her own will.

In some embodiments, when receiving the terminal identification of at least one candidate terminal to be designated as the verification terminal, the first terminal may display the terminal identification of at least one candidate terminal in the interface. The first user may select a verification terminal by choosing the terminal identification of a second terminal. When receiving the verification terminal selecting instruction inputted by the first user, i.e., the first user's selection of the terminal identification of the second terminal, the first terminal may send the terminal identification of the second terminal to the server.

In some embodiments, after receiving the terminal identifications of all candidate terminals for a verification terminal sent by the server, the first terminal may display the terminal identifications of all candidate terminals in the interface. The first user may select a verification terminal by choosing a terminal identification of the second terminal to cause the first terminal to display an input box for inputting a verification password. The first user may input the verification password and click a confirmation key to cause the first terminal to send the terminal identification of the second terminal and the verification password to the server, where the second terminal is the selected verification terminal.

In step 504, the server receives the terminal identification of the selected second terminal sent by the first terminal.

In step 505, the server adds the target identification and the second terminal into a database indicating the corresponding relationship between identification information and verification terminals.

In some embodiments, after receiving the terminal identification of the second terminal selected by the first user sent by the first terminal, the server may obtain the target identification of the target account which is used to log in the application program in the first terminal, and the service identification of the target network service. The server stores the target identification of the target account and the terminal identification of the second terminal in the database indicating the corresponding relationship between identification information and verification terminals. In some embodiments, when storing the target identification of the target account, the server also stores the service identification of the target network service.

In some embodiments, the server may receive a verification password, acquire the target account which is used to log in the application program in the first terminal, and the service identification of the target network service, and stores the verification password of the target network service of the target account.

In the embodiments of the present disclosure, the server receives the network service request sent by the first terminal. The network service request includes a target identification of the target account. The server determines a second terminal corresponding to the target identification according to the pre-stored corresponding relationship between the identification information and the verification terminals and sends a verification request to a second terminal. When receiving a verification confirmation message sent by the second terminal, the server executes a network service corresponding to the network service request. In this way, the user, when allowing other users to use his/her account to execute the network service, may use the verification terminal to remotely grant the network service request without providing the service executing password to the other users, thereby improving the account security.

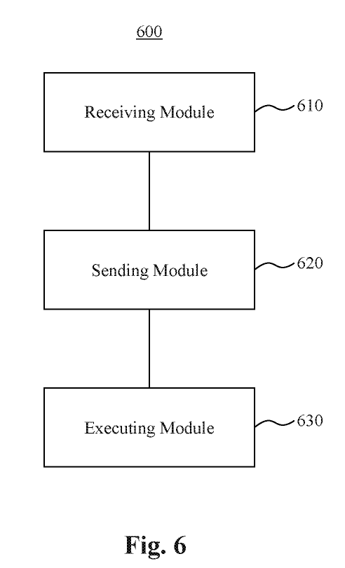

FIG. 6 is a block diagram illustrating a server 600, according to an exemplary embodiment. The server 600 may be employed as the server in the methods explained above. As shown in FIG. 6, the server 600 includes a receiving module 610, a sending module 620, and an executing module 630.

The receiving module 610 is configured to receive a network service request sent by a first terminal. The network service request includes a target identification.

The sending module 620 is configured to determine a second terminal corresponding to the target identification included in the network service request received by the receiving module according to a pre-stored corresponding relationship between identification information and verification terminals, and send a verification request to the second terminal.

The executing module 630 is configured to, when receiving a verification confirmation message from the second terminal, execute a network service corresponding to the network service request.

In some embodiments, the executing module 630 is further configured to, when receiving the verification confirmation message sent by the second terminal, acquire a verification password included in the verification confirmation message, determine whether the verification password matches a pre-stored verification password corresponding to the target identification, and execute the network service corresponding to the network service request when they match with each other.

In some embodiments, the network service request includes a terminal identification of the first terminal.

The sending module 620 is configured to send a verification request including the terminal identification of the first terminal to the second terminal.

In some embodiments, the receiving module 610 is further configured to receive a verification terminal setting request sent by the first terminal.

The sending module 620 is further configured to determine a target account corresponding to the target identification, and send to the first terminal a terminal identification of at least one terminal other than the first terminal in which the target account is used, as a candidate for a verification terminal.

The receiving module 610 is further configured to receive a terminal identification of a selected second terminal sent by the first terminal.

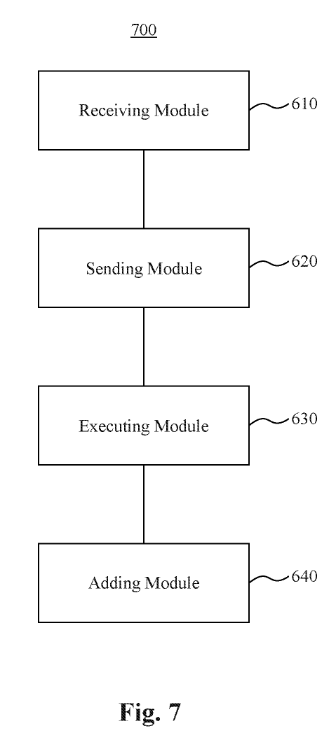

FIG. 7 is a block diagram illustrating a server 700, according to an exemplary embodiment. The server 700 may be employed as the server in the methods explained above. As shown in FIG. 7, the server 700 includes a receiving module 610, a sending module 620, an executing module 630, and an adding module 640. The receiving module 610, sending module 620, and executing module 630 are similar to those of server 600 (FIG. 6).

The adding module 640 is configured to add the target identification of the second terminal into a database indicating the corresponding relationship between the identification information and the verification terminals.

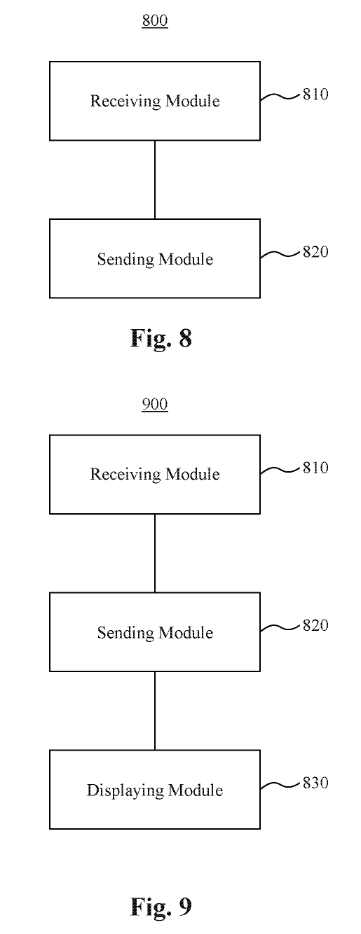

FIG. 8 is a block diagram illustrating a first terminal 800, according to an exemplary embodiment. The first terminal 800 may be employed as the first terminal in the methods explained above. As shown in FIG. 8, the first terminal 800 includes a receiving module 810 and a sending module 820.

The receiving module 810 is configured to receive a network service instruction in a remote verification mode inputted by a user.

The sending module 820 is configured to send a network service request corresponding to the network service instruction received by the receiving module to a server. The network service request includes a target identification for enabling the server to determine a second terminal corresponding to the target identification according to a pre-stored corresponding relationship between identification information and verification terminals, send a verification request to the second terminal, and when receiving a verification confirmation message sent by the second terminal, execute a network service corresponding to the network service request.

In some embodiments, the receiving module 810 is further configured to receive a verification terminal setting instruction inputted by a user, and the sending module 820 is further configured to send the verification terminal setting request to the server.

The receiving module 810 is further configured to receive a terminal identification of at least one terminal which has logged in to the target account, the target account corresponding to the target identification. The at least one terminal is a candidate for a verification terminal.

FIG. 9 is a block diagram illustrating a first terminal 900, according to an exemplary embodiment. The first terminal 900 may be employed as the first terminal in the methods explained above. As shown in FIG. 9, the first terminal 900 includes a receiving module 810, a sending module 820, and a displaying module 830. The receiving module 810 and sending module 820 are similar to those of the first terminal 800 (FIG. 8).

The displaying module 830 is configured to display the received terminal identification of at least one terminal as a candidate for a verification terminal.

The sending module 820 is further configured to, when receiving a verification terminal selecting instruction inputted by the user that selects a second terminal as the verification terminal, send the terminal identification of the second terminal to the server.

In the embodiments of the present disclosure, the server receives the network service request sent by the first terminal. The network service request includes a target identification. The server determines a second terminal corresponding to the target identification according to the pre-stored corresponding relationship between the identification information and the verification terminals and sends a verification request to the second terminal. When receiving a verification confirmation message sent by the second terminal, the server executes a network service corresponding to the network service request. In this way, the user, when allowing other users to use her account to execute the network service, may use the verification terminal to remotely grant the network service request without providing the service executing password to the other users, thereby improving the account security.

With respect to the server and the first terminal in the above embodiments, the specific manners for performing operations of individual modules therein have been described in detail in the embodiments regarding the methods, which will not be elaborated herein.

The apparatus embodiments described above are merely illustrative. The modules described as separate may be or may not be physically separate. A part of or all of the modules can be selected to achieve the objective of the present disclosure as desired.

Another exemplary embodiment of the present disclosure provides a system for executing a network service. The system includes a server and a first terminal consistent with the servers and first terminals explained above and are configured to perform the methods for performing network services described above.

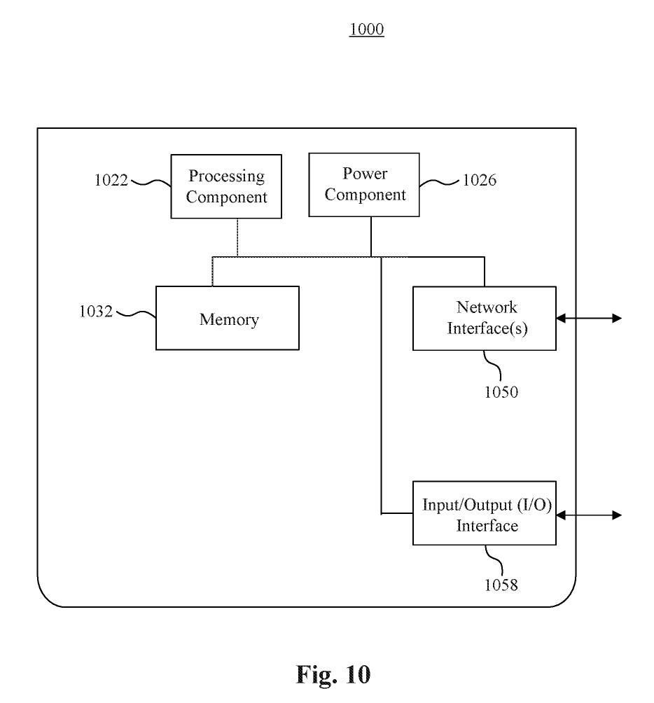

FIG. 10 is a block diagram of a server 1000, according to an exemplary embodiment. The server 1000 may be employed as the server in the methods and apparatuses explained above.

As shown in FIG. 10, the server 1000 includes a processing component 1022 that further includes one or more processors, and memory resources represented by a memory 1032 for storing instructions executable by the processing component 1022, such as application programs. The application programs stored in the memory 1032 may include one or more modules each corresponding to a set of instructions. In addition, the processing component 1022 is configured to execute instructions so as to perform the above methods.

The server 1000 may also include a power component 1026 configured to perform power management of the server 1000, wired or wireless network interface(s) 1050 configured to connect the server 1000 to a network, and an input/output (I/O) interface 1058. The server 1000 may operate based on an operating system stored in the memory 1032, such as Windows Server™, Mac OS X™, Unix™, Linux™, FreeBSD™, or the like.

The server 1000 may include one or more programs stored in memory 1032, which may be executed by one or more processors of the processing component 1022, causing the one or more processors to perform the above methods.

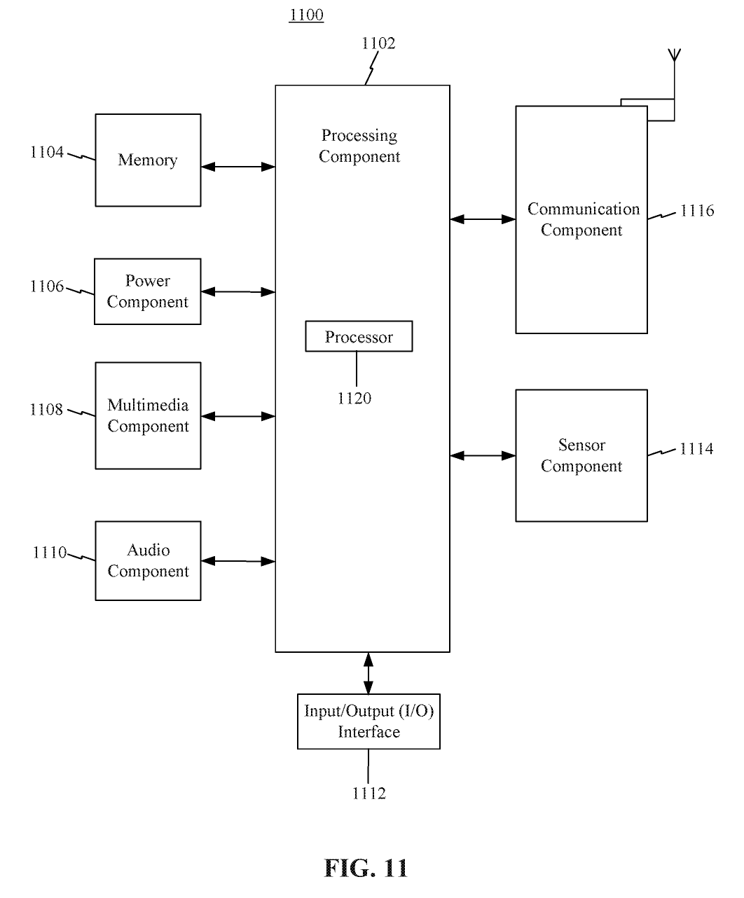

FIG. 11 is a structural diagram of a terminal 1100, according to an exemplary embodiment. The terminal 1100 may be a mobile phone, a tablet computer, a smart TV, and the like, and may be employed as the first terminal or the second terminal explained above.

As shown in FIG. 11, the terminal 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the terminal 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the terminal 1100. Examples of such data include instructions for any applications or methods operated on the terminal 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the terminal 1100. The power component 1106 may include a power management system, one or more power sources, and any other components associated with the generation, management, and distribution of power in the terminal 1100.

The multimedia component 1108 includes a screen providing an output interface between the terminal 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and/or the rear camera may receive an external multimedia datum while the terminal 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (“MIC”) configured to receive an external audio signal when the terminal 1100 is in an operation mode, such as a call mode, a recording mode, and a voice recognition mode. The received audio signal may be further stored in the memory 1104 or transmitted via the communication component 1116.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the terminal 1100. For instance, the sensor component 1114 may detect an open/closed status of the terminal 1100, relative positioning of components, e.g., the display and the keypad, of the terminal 1100, a change in position of the terminal 1100 or a component of the terminal 1100, a presence or absence of user contact with the terminal 1100, an orientation or an acceleration/deceleration of the terminal 1100, and a change in temperature of the terminal 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the terminal 1100 and other devices. The terminal 1100 can access a wireless network based on a communication standard, such as WiFi, 2G, 3G, or 4G or a combination thereof. In one exemplary embodiment, the communication component 1116 receives a broadcast signal or broadcast associated information from an external broadcast management system via a broadcast channel. In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1104, executable by the processor 1120 in the terminal 1100, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for executing a network service, comprising:
receiving a network service request sent by a first terminal, the network service request including a target identification;
determining a second terminal corresponding to the target identification according to a pre-stored corresponding relationship between identification information and verification terminals, and sending a verification request to the second terminal; and
when receiving a verification confirmation message from the second terminal, executing a network service corresponding to the network service request.

2. The method of claim 1, wherein the executing of the network service corresponding to the network service request comprises:
when receiving the verification confirmation message from the second terminal, extracting a verification password in the verification confirmation message, determining whether the verification password matches a pre-stored verification password corresponding to the target identification, and executing the network service corresponding to the network service request when the verification password matches the pre-stored verification password.

3. The method of claim 1, wherein the network service request includes a terminal identification of the first terminal; and
the sending of the verification request to the second terminal comprises:
sending the verification request including the terminal identification of the first terminal to the second terminal.

4. The method of claim 1, before the receiving of the network service request sent by the first terminal, the method further comprising:
receiving a verification terminal setting request sent by the first terminal;
determining a target account corresponding to the target identification;
sending to the first terminal a terminal identification of at least one terminal which has logged in to the target account;
receiving a terminal identification of the second terminal from the first terminal; and
adding the target identification and the second terminal into the corresponding relationship between the identification information and the verification terminals.

5. A server, comprising:
a processor; and
a memory for storing instructions executable by the processor;
wherein the processor is configured to:
receive a network service request sent by a first terminal, the network service request including a target identification;
determine a second terminal corresponding to the target identification according to a pre-stored corresponding relationship between identification information and verification terminals, and send a verification request to the second terminal; and
when receiving a verification confirmation message from the second terminal, execute a network service corresponding to the network service request.

6. The server of claim 5, wherein the processor is further configured to:
when receiving the verification confirmation message from the second terminal, extract a verification password in the verification confirmation message, determine whether the verification password matches a pre-stored verification password corresponding to the target identification, and execute the network service corresponding to the network service request when the verification password matches the pre-stored verification password.

7. The server of claim 5, wherein the network service request includes a terminal identification of the first terminal; and
wherein the processor is further configured to:
send the verification request including the terminal identification of the first terminal to the second terminal.

8. The server of claim 5, wherein before the receiving of the network service request sent by the first terminal, the processor is further configured to:
receive a verification terminal setting request sent by the first terminal;
determine a target account corresponding to the target identification;
send to the first terminal a terminal identification of at least one terminal which has logged into the target account;
receive a terminal identification of the second terminal from the first terminal; and
add the target identification and the second terminal into the corresponding relationship between the identification information and the verification terminals.

9. A first terminal, comprising:
a processor; and
a memory for storing instructions executable by the processor;
wherein the processor is configured to:
receive a network service instruction in a remote verification mode inputted by a user; and
send a network service request to a server, wherein the network service request includes a target identification for enabling the server to determine a second terminal corresponding to the target identification according to a pre-stored corresponding relationship between identification information and verification terminals, send a verification request to the second terminal, and when receiving a verification confirmation message from the second terminal, execute a network service corresponding to the network service request.

10. The first terminal of claim 9, wherein the processor is further configured to:
receive a verification terminal setting instruction inputted by a user;
send a verification terminal setting request to the server based on the verification terminal setting instruction;
receive, from the server, a terminal identification of at least one terminal which has logged into a target account corresponding to the target identification;
display the received terminal identification of the at least one terminal; and
when receiving a verification terminal selecting instruction inputted by the user, send the terminal identification of the second terminal selected by the verification terminal selecting instruction to the server.
